(19) United States
(12) Patent Application Publication
(10) Pub. No.: US 2015/0124648 A1
(43) Pub. Date: May 7, 2015

(54) COMMUNICATION METHOD IN SOFTWARE DEFINED NETWORK (SDN) USING HERARTCHICAL STRUCTURE AND SDN SYSTEM

(71) Applicant: ELECTRONICS AND TELECOMMUNICATIONS RESEARCH INSTITUTE, Daejeon (KR)

(72) Inventors: Byung Joon LEE, Daejeon (KR); Ji Soo SHIN, Daejeon (KR); Sae Hyong PARK, Daejeon (KR)

(21) Appl. No.: 14/533,193

(22) Filed: Nov. 5, 2014

(30) Foreign Application Priority Data
Nov. 6, 2013 (KR) 10-2013-0134422
Sep. 24, 2014 (KR) 10-2014-0127911

(51) Int. Cl. H04L 12/24; H04L 29/12

(52) U.S. Cl. CPC H04L 41/0893; H04L 61/103
USPC 370/254

(57) ABSTRACT

A communication method in a software defined network (SDN) using a hierarchical structure and a system thereof are provided. The communication method includes separating a transport plane and a control plane from each other; hierarchically partitioning the control plane into a plurality of lower-level controllers and a upper-level controller that is configured to integratedly manage the plurality of lower-level controllers; and controlling communication among unit networks or through at least one unit network by using a hierarchical structure of the control plane.

### CROSS-REFERENCE TO RELATED APPLICATION(S)

This application claims priority from Korean Patent Application Nos. 10-2013-0134422, filed on Nov. 6, 2013, and 10-2014-0127911, filed on Sep. 24, 2014, in the Korean Intellectual Property Office, the entire disclosures of which are incorporated herein by reference for all purposes.

### BACKGROUND

1. Field

The following description relates to a technology for network communication and management, and particularly to a software defined network (SDN) technology.

2. Description of the Related Art

There are technologies of separating a control plane from a transport plane in a network so that the network may have a flexible configuration. One of the technologies is a software defined network (SDN), which separates a transport plane and a control plane from each other, wherein the transport plane asks the control plane about every decision of transmitting a packet, so it is possible to control a network configuration and a packet flow using software installed in the transport plane in a centralized manner. A control plane in the SDN is generally called an AND controller.

If a control plane of a network is centralized on one controller, it is possible to control a packet transmission process using software. In this case, functions of all transport devices are controlled by only one controller, so that it may cause network scalability issue. The larger a network is, the more traffic a controller needs to deal with, since all the transport devices communicate with the only one controller. In addition, in a case where a single controller controls a transport network, it is hard for a manager to understand and manage a complicated structure of a large network.

### SUMMARY

The following description relates to a communication method in a software defined network (SDN) using a hierarchical structure for easier network control and management, and to an SDN system.

In one general aspect, there is provided a communication method in a software defined network (SDN), including: separating a transport plane and a control plane from each other; hierarchically partitioning the control plane into a plurality of lower-level controllers and a upper-level controller that is configured to integratedly manage the plurality of lower-level controllers; and controlling communication among unit networks or through at least one unit network by using a hierarchical structure of the control plane.

In another general aspect, there is provided a software-defined network (SDN) system including: a plurality of lower-level controller configured to manage different unit networks, respectively; and an upper-level controller configured to manage the plurality of lower-level controllers, wherein in a case where the plurality of lower-level controllers abstract the respective unit networks and provide the abstracted unit networks to the upper-level controller, the upper-level controller controls communication between the abstracted unit networks.

Other features and aspects may be apparent from the following detailed description, the drawings, and the claims.

### BRIEF DESCRIPTION OF THE DRAWINGS

FIG. 1 is a diagram illustrating a software defined network (SDN) of a hierarchical structure according to an exemplary embodiment.

FIG. 2 is a diagram illustrating a unit network according to an exemplary embodiment.

FIG. 3 is a diagram illustrating a network structure for communication between unit networks using a hierarchical structure in an SDN according to an exemplary embodiment.

FIG. 4 is a diagram illustrating a network structure for communication between unit networks using a hierarchical structure in an SDN according to another exemplary embodiment.

FIG. 5 is diagram illustrating a network structure for communication between unit networks using an IP network in an SDN according to an exemplary embodiment.

FIG. 6 is a diagram illustrating a network structure for communication between IP networks through a unit network in an SDN according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

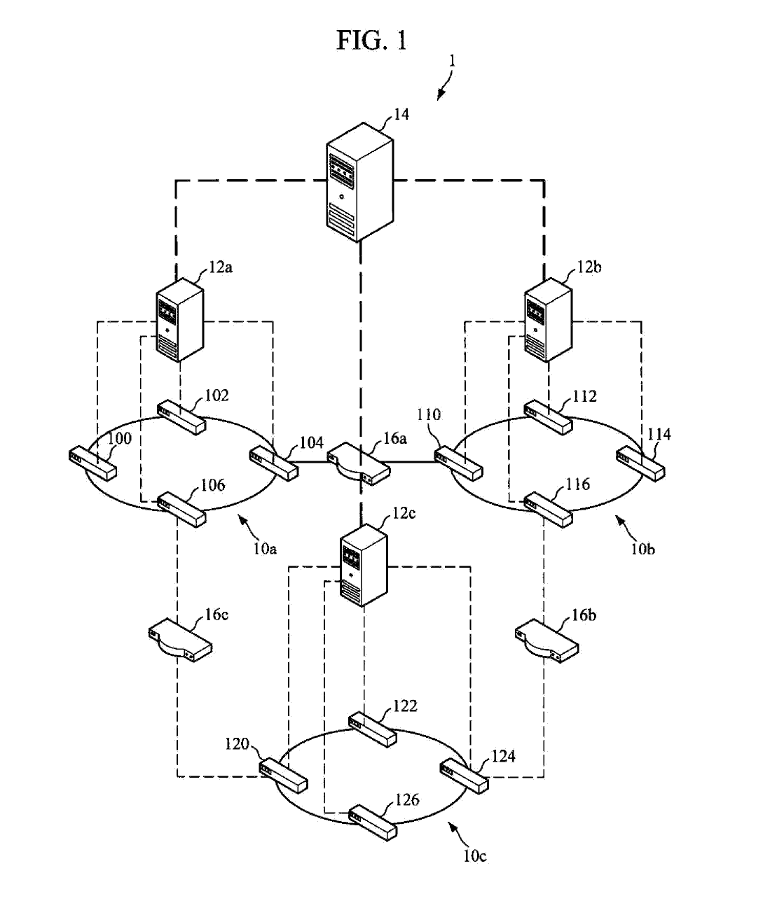

FIG. 1 is a diagram illustrating a software defined network (SDN) with a hierarchical structure according to an exemplary embodiment.

Referring to FIG. 1, there is provided a SDN which consists of three unit networks 10a, 10b and 10c. Each of the unit networks 10a, 10b and 10c is a network in which a control plane and a transport plane are separate from each other. A control plane of each of the unit networks 10a, 10b and 10c is a controller, and a transport plane of each of the unit networks includes a plurality of transport devices and at least one router.

For example, a control plane of the first unit network 10a includes the first lower-level controller 12a in charge of a plurality of the first transport devices 100, 102, 104 and 106, the second lower-level controller 12b in charge of a plurality of the second transport devices 110, 112, 114 and 116, and the third unit network 10c includes a third lower-level controller 12c in charge of a plurality of the third transport devices 120, 122, 124 and 126. Each of the lower-level controllers 12a, 12b and 12c is connected to an upper-level controller 14, so that the upper-level controller 14 manages and controls the lower-level controllers 12a, 12b and 12c.

A router connects the unit networks. For example, the first router 16a connects the first and second unit networks 10a and 10b, the second router 16b connects the second and third unit networks 10b and 10c, and the third router 16c connects the first and third unit networks 10a and 10c.

Referring to FIG. 1, the control plane is hierarchically partitioned into the upper-level controller 14 and a plurality of the lower-level controllers 12a, 12b and 12c. Instead of controlling the entire SDN network 1, the upper-level controller 14 controls only communication between unit networks. That is, if the lower-level controllers 12a, 12b and 12c abstract the respective unit networks 10a, 10b and 10c and then transmit the, abstracted unit networks to the upper-level controller 14, the upper-level controller 14 may control the entire network without knowing specific configurations of the respective unit networks 10a, 10b and 10c. Thus, it may become less complicated to control a network.

Meanwhile, although FIG. 1 illustrates only a two-level hierarchical structure of a controller, that is, an upper level and a lower-level, but this structure may be expanded to an arbitrary scale. In addition, although FIG. 1 illustrates only three unit networks, the number of unit networks and the number of elements composing each unit network may be less or more.

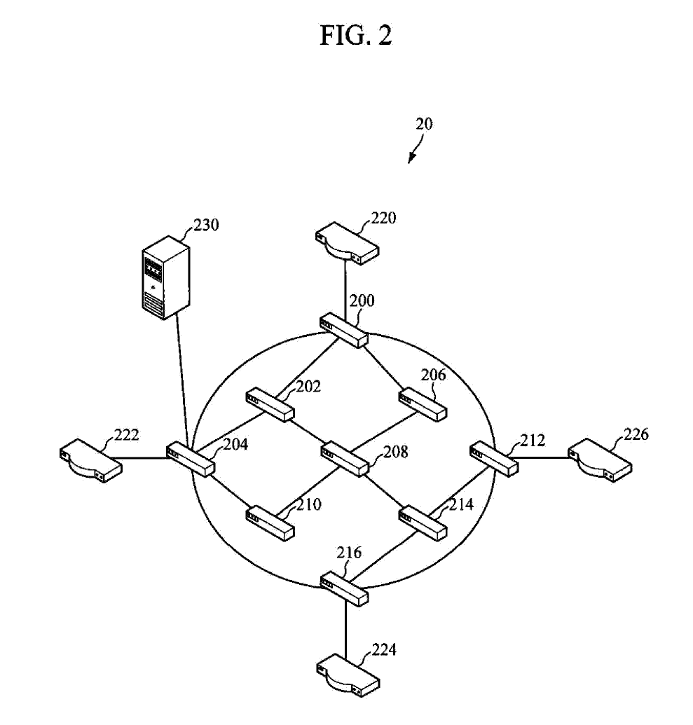

FIG. 2 is a diagram illustrating a unit network according to an exemplary embodiment.

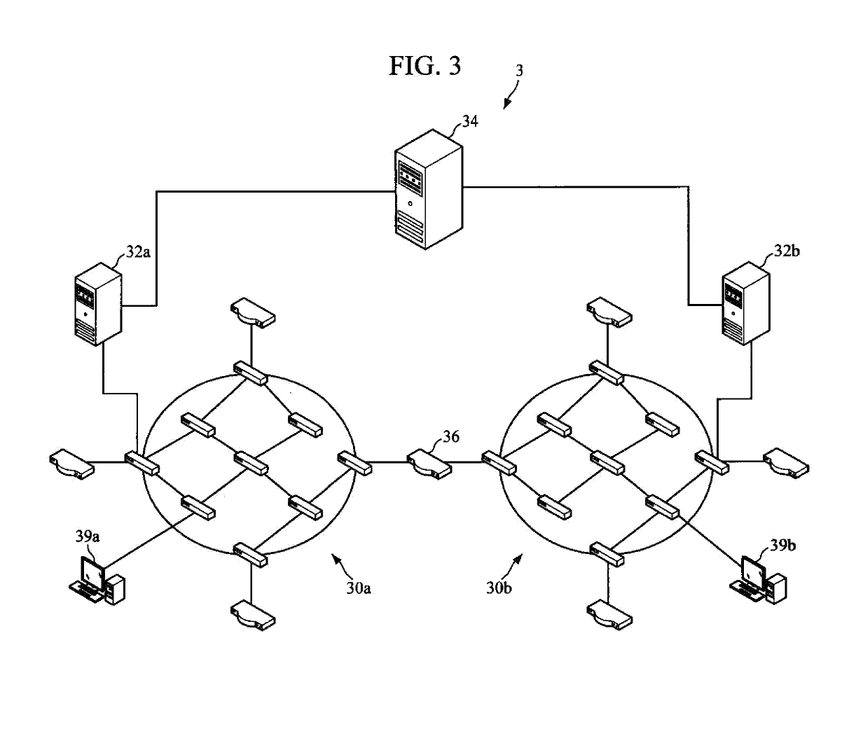

Referring to FIG. 3, there is provided a unit network 20, and the unit network 20 includes a plurality of transport devices 200, 2002, . . . , 216 connected by an arbitrary topology, a plurality of routers 220, 222, 224 and 226 connecting the unit network 20 to an external unit network, and a controller 230. An existing router may be used without any structural change. In addition, a router may be implemented by using a controller to control a transport device. For example, it is possible to use a transport device as an IP router by using the controller to control the transport device to process a specific packet the same way as does the IP router. In addition, although not illustrated in FIG. 2, various terminals, for example, computers, may be connected to each transport device.

In order to transmit a packet, which is transmitted and received between terminals in a unit network, to a desired terminal, a transport device in the unit network asks a controller about a port to which the packets need to be transmitted. To respond the ask, the controller may acquire in advance not just a link layer address information and IP address information of each terminal in the unit network, and information on a transport device accessed by each terminal in the unit network, but information on link connection between transport devices, by analyzing a protocol packet operating on a link layer. Based on the above-described information, the controller may acquire a connection structure, that is, topology infortnation, of a unit network. Further, an IP address range of each terminal within a single unit network may be input in advance to the controller. In addition, IP address information and link layer address information of a router that transmits packets to an external unit network may be input in advance to the controller. The above-described prior procedures may be summed up as below:

[Prior Procedure 1]

For communication between unit networks or for communication through a unit network, a lower-level controller of a unit network according to an exemplary embodiment transmits the following information to an upper-level controller using a controller association protocol. That is, a lower-level controller transmits, to an upper-level controller, IP address range information of each terminal in a unit network. The IP address range information may be briefly represented by classless inter-domain routing (CIDR) and the like. In addition, the lower-level controller transmits, to the upper-level controller, a router's IP address and MAC address, which is information on a router that is to be connected to an external unit network. Transmission of the above-described information may be performed periodically. The above-described information is used for terminal-to-terminal communication that needs to go through a plurality of unit networks. The upper-level controller may identify connection among unit networks using the above-described information, and identify an IP address range of terminals in each unit network.

[Prior Procedure 2]

A controller of a unit network according to an exemplary embodiment transmits the following information to a router connected the unit network. That is, the controller transmits information on IP address range of terminals that are connected through transport devices to the router. The above-described information are used to enable each router to transmit/receive information on IP address range of terminals installed in the entire network through a traditional IP routing protocol, such as open shortest path first (OSPF), and to enable each router to transmit packets distributed among unit networks to a desired destination.

Based on a network environment satisfying the above-described prior procedures, various exemplary embodiments of the present disclosure are described with reference to FIGS. 3 to 6. To provide a better understanding of the present disclosure, it is assumed that a transmitting terminal and a receiving terminal communicate with each other through various unit networks.

FIG. 3 is a diagram illustrating a network structure for communication between unit networks using a hierarchical structure in an SDN according to an exemplary embodiment.

[Procedure 1-1]

Referring to FIG. 3, when a transmitting terminal 39a in the first unit network 30a wishes to communicate with a receiving terminal 39b in the second unit network 30b, the transmitting terminal 39a attempts to transmit a packet to an IP address of the receiving terminal 39b. In this course, an ARP REQUEST message occurs. If receiving, from a transport device in the first unit network 30a, a query message about how to process the received packet, the first lower-level controller 32a checks if an IP address of the receiving terminal 39b, which is included in the query message, is within the first unit network 30a. If the IP address of the receiving terminal 39b is not within the first unit network 30a, the first lower-level controller 32a transmits, to an upper-level controller 34 on an upper layer, the query message about how to process the received packet.

As already informed by [Prior Procedure 1] that the receiving terminal 39b is within the second unit network 30b, the upper-level controller 34 controls a transport device to reply the transmitting terminal 39a by including a link structure address (MAC address) of router A 36 connected to the second unit network 30b to an ARP REPLY message. As a result, the transmitting terminal 39a is informed that it is necessary to transmit a packet to the MAC address of the router A 36 in order to transmit the packet to an IP address of the receiving terminal 39b. Thus, the transmitting terminal 39a transmits the packet by allocating the MAC address of the router A 36 to the MAC address of the receiving terminal 39b.

[Procedure 1-2]

If the packet transmitted from the transmitting terminal 39a reaches the router A 36, the router A 36 changes an MAC address of the transmitting terminal 39a to the MAC address of the router A 36. However, as not informed of the MAC address of the receiving terminal 39b, the router A 36 transmits, to a transport device in the second unit network 30b, an ARP REQUEST packet including an IP address of the receiving terminal 39b. In response to receipt of the ARP REQUEST packet through the transport device, the second lower-level controller 32b checks that the IP address of the receiving terminal 39b is an IP address within in a network in which the second lower-level controller is located. Then, the second lower-level controller 32b directs a transport device of the second unit network 30b to distribute the ARP REQUEST packet within the network to transmit the ARP REQUEST packet to the receiving terminal 39b. In response to the direction, the transport device transmits the ARP REQUEST packet to the receiving terminal 39b. In response to the ARP REQUEST packet, the receiving terminal 39b informs the router A 36 of the MAC address of the receiving terminal 39b by ARP REPLY, which corresponds to an IP address thereof. As a result, the router A 36 records the MAC address of the receiving terminal 39b, to which the IP packet needs to be transmitted, and transmits the IP packet to the MAC address of the receiving terminal 39b, so that the IP packet reaches the receiving terminal 39b of the destination.

[Assumption 1]

Using a controller to control transmission of a packet within a unit network is a general and well-known technique in an SDN. That is, it is possible to transmit a packet from the router A 36 to the receiving terminal 39b using the well-known technique, so detailed descriptions thereof are omitted.

[Assumption 2]

It is assumed that each unit network and a controller managing the same have a function that enables transmission of a routing protocol packet, such as an OSPF packet, to every router connected to the corresponding network.

Meanwhile, the embodiment described above with reference to FIG. 3 may be applied even in a case in which an upper-level controller is connected to a lower-level controller of a different upper-level controller.

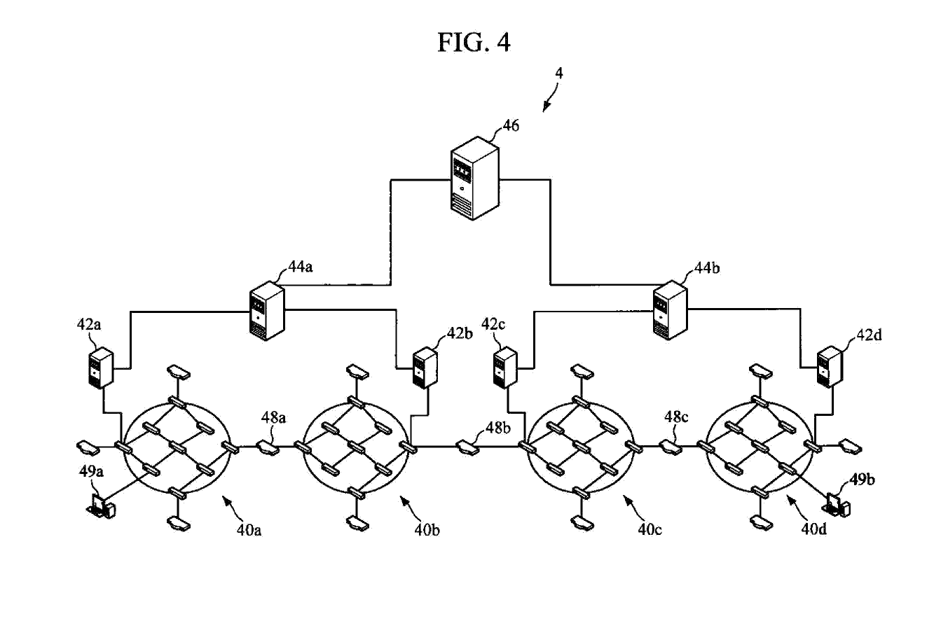

FIG. 4 is a diagram illustrating a network structure for communication between unit networks using a hierarchical structure in an SDN according to another exemplary embodiment.

[Procedure 2-1]

Referring to FIG. 4, there are four unit networks 40a, 40b, 40c and 40d, and it is assumed that a transmitting terminal 49a in the first unit network 40a transmits a packet to a receiving terminal 49b in the fourth unit network 40d. If the transmitting terminal 49a transmits an ARP REQUEST packet to an IP address of the receiving terminal 49b in order to acquire an MAC address of the receiving terminal 49b, the transmitting terminal 49a asks the first lower-level controller 42a allocated to the first unit network 40a about how to process the ARP REQUEST packet. The first lower-level controller 42a checks that the received IP address is not an IP address within the first unit network 40a, and then asks the first upper-level controller 44a about how to the ARP REQUEST packet, since first lower-level controller 42a is not informed of where to transmit the ARP REQUEST packet. In response to the ask, the first upper-level controller 44a checks that the received IP address is not an IP address in both of the first unit network 40a and the second unit network 40b, and asks the top-level controller 46 about how to process the ARP REQUEST packet.

As already informed in [Prior Procedure 1] of that the received IP address is within the fourth unit network 40d managed by the second upper-level controller 44b, the top-level controller 46 replies to the first upper-level controller 44a by transmitting IP and MAC addresses of router B 48b. Since the first upper-level controller 44a is informed by [Prior Procedure 1] that a packet needs to transmitted to the router A 48a and then to the router b 48b, the first upper-level controller 44a replies the first lower-level controller 42a in response to receipt of the IP and MAC addresses of the router b 48b by transmitting the received IP and MAC addresses of the router B 49b. The first lower-level controller 42a transmits an ARP REPLY packet including IP and MAC addresses of the router A 48a to the transmitting terminal 49a, and the transmitting terminal 49a transmits, to the router A 48a, an IP packet to be transmitted to an IP address of the receiving terminal 49b.

[Procedure 2-2]

If the IP packet transmitted from the transmitting terminal 49a reaches the router A 48a, a MAC address of the transmitting terminal 49a is changed into the MAC address of the router A 48a. In a case where the router A 48a is not informed of the MAC address of the router B 48b through which the packet need to be transmitted to an IP address of the receiving terminal 49b, an ARP REQUEST message including the IP address of the receiving terminal 49b is transmitted to a transport device in the second unit network 40b. At this point, the ARP REQUEST message is transmitted through the second lower-level controller 42b and the first upper-level controller 44a to the top-level controller 46 that is informed, of the MAC address of the router B 48b. The top-level controller 46 confirms that the packet needs to be transmitted to the router B 48b, and the router A 48a changes the destination MAC address, to which a packet is to be transmitted, to the MAC address of the router B 48B, and then transmits an IP packet to the router B 48b.

If [Prior Procedure 2] is properly performed and [Assumption 3] is satisfied, the router A 48a may be in advance informed of the MAC address of the router B 48b and of the fact that the router B 48b is the next router to reach the final destination. In this case, the above-described [Procedure 2-2] may be omitted.

[Procedure 2-3]

As [Procedure 2-2] is performed repeatedly, the packet finally enters the fourth unit network 40d in which the receiving terminal 49b is located, and the packet is transmitted within the fourth unit network 40d in accordance with [Procedure I-2].

The embodiments described above with reference to FIGS. 3 and 4 are about a procedure of realizing end-to-end packet delivery using ARP REQUEST and ARP REPLY packets. However, this present disclosure may be modified and applied in a different packet processing procedure.

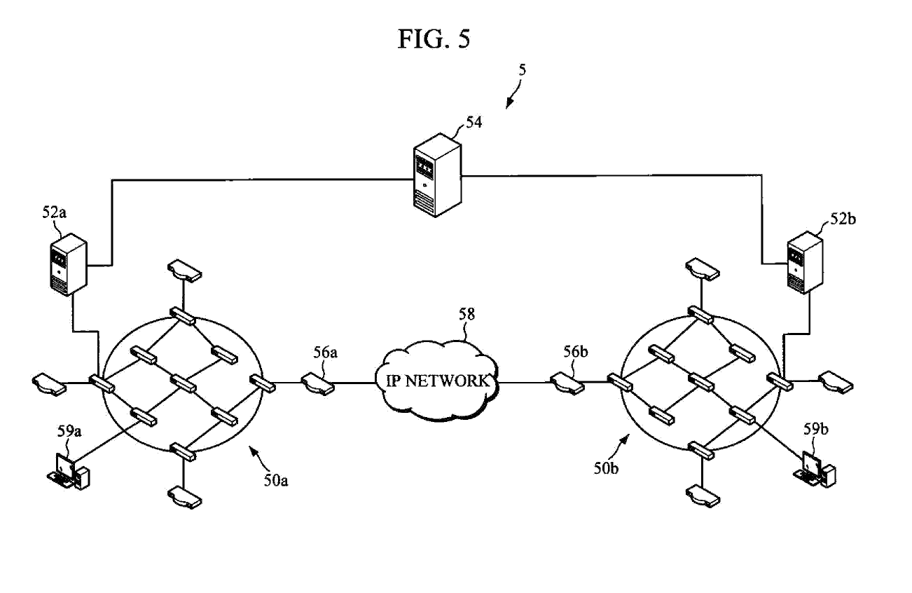

Meanwhile, the present disclosure may be applied even in a case where a different specific IP network exists between unit networks. For example, the present disclosure may be applied even in a case where a different specific IP network between unit networks, as shown in FIG. 5. It is possible because an IP router on the edge of a unit network processes transmission of a packet to the IP network.

FIG. 5 is a diagram illustrating a network structure for communication between unit networks through an IP network according to an exemplary embodiment.

Referring to FIG. 5, it is possible for terminals in each unit network to communicate with each other though there is an IP network in between. An upper-level controller 54 is informed by the first lower-level controller 52a of an IP address range of the first unit network 50a, and by the second lower-level controller 52b of an IP address range of the second unit network 50b. Information on connection between the router A 56a and the router B 56b through the IP network 58 may be manually input to the upper-level controller 54 or may be collected and managed by analyzing a routing protocol packet transmitted and received between the routers A 56a and the 56b. That is, due to the availability of collecting and managing the whole network structure, the upper-level controller 54 is informed that a packet transmitted from the transmitting terminal 59a to the receiving terminal 59b needs to pass through the router A 56a. Thus, if the transmitting terminal 59a transmits a packet to the router A 56a, the packet is transmitted to the router B 56b by an existing IP routing protocol.

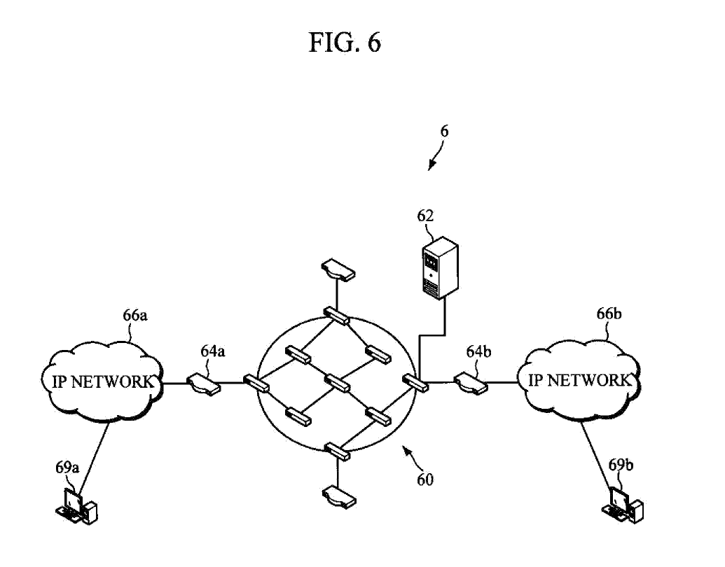

FIG. 6 is a diagram illustrating a network structure for communication between IP networks through a unit network in an SDN according to an exemplary embodiment.

Referring to FIG. 6, IP networks may communicate with one another through one or more unit networks. For example, as shown in FIG. 6, IP networks 66a and 66b may communicate with each other through at least one unit network 60. As acknowledging the whole network structure including the unit network 60 through [Prior Procedure 2], the router A 64a and the router B 64b may transmit a packet from the transmitting terminal 69a to the receiving terminal 69b properly. This procedure is performed in accordance with a procedure of transmitting a packet in a conventional IP network. The reference number 62 in FIG. 6 indicates a controller which is configured to manage the unit network 60.

IP technologies are assumed in the descriptions provided above with the drawings. However, it is possible to apply the similar version of the present invention to an arbitrary network protocol.

According to an exemplary embodiment, a control plane is partitioned into upper-level controllers and lower-level controllers, and the upper-level controller controls only communication between unit networks, instead of controlling the entire network. That is, each lower-level controller abstracts a unit network managed by each lower-level controller and provides the abstracted unit network to a corresponding upper-level controller, and then the corresponding upper-level controller controls communication between the abstracted unit networks. Accordingly, the upper-level controller is able to control the entire network without knowing a specific configuration of each unit network managed by a different lower-level controller, so that it may become less complicated to control a network.

Further, by partitioning a large network into unit networks, allocating different controllers to the unit networks and by hierarchically associating the different controllers with each other, it is possible to reduce the number of transport devices to be managed by each controller and thus solve network scalability. Further, it is possible to associate unit networks with an arbitrary different network, for example, an IP network.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method in, a software defined network (SDN), comprising:
separating a transport plane and a control plane from each other;
hierarchically partitioning the control plane into a plurality of lower-level controllers and a upper-level controller that is configured to integratedly manage the plurality of lower-level controllers; and
controlling communication among unit networks or through at least one unit network by using a hierarchical structure of the control plane,

2. The communication method of claim 1, wherein the controlling of communication comprises:
abstracting, by a plurality of lower-level controllers, different unit networks and providing the abstract unit networks to the upper-level controller; and
controlling, by the upper-level controller, communication between abstracted unit networks.

3. The communication method of claim 1, wherein each lower-level controller transmits, to the upper-level controller, IP address range information of at least one terminal included in a first unit network, an IP address of a router connecting the first unit network and a second unit network, and link layer address, information.

4. The communication method of claim 1, further comprising:
transmitting, by a lower-level controller, IP address range information of at least one terminal included in a first unit network managed by the lower-level controller to a router that connects the first unit network and a second unit network.

5. The communication method of claim 1,
wherein the SDN comprises:
a first IP network connected to a transmitting terminal;
a second IP network connected to a receiving terminal;
a first router connected to the first IP network;
a second router connected to the second IP network; and
at least one unit network connecting the first router and the second router,
wherein the communication method further comprises transmitting, by a controller configured to manage the at least one unit network, IP address range information of terminals in the at least one unit network to a router connected to the at least one unit network, so that the transmitting terminal connected to the first IP network transmits a packet through the at least one unit network to the receiving terminal connected to the second IP network.

6. The communication method of claim 1,
wherein the SDN comprises:
a first unit network comprising a transmitting terminal;
a second unit network comprising a receiving terminal;
a router connecting the first unit network and the second unit network;
a first lower-level controller configured to manage the first unit network;
a second lower-level controller configured to manage the second unit network; and
an upper-level controller configured to manage the first lower-level controller and the second lower-level controller,
wherein the controlling of communication comprises:
transmitting, by the transmitting terminal in the first unit network, a query message including an IP address of the receiving terminal in the second unit network to the first lower-level controller in order to transmit a packet to the receiving terminal; and
checking, by the first lower-level controller, if the IP address of the receiving terminal is within the first unit network, and, if not, transmitting the query message to the upper-level controller.

7. The communication method of claim 6, wherein the controlling of communication further comprises:
checking, by the upper-level controller having received the query message, that the receiving terminal is within the second unit network, and transmits a link layer address of the router to the transmitting terminal; and
transmitting, by the transmitting terminal, a packet to the link layer address of the router.

8. The communication method of claim 6,
wherein the router comprises a first router and a second router which are connected to each other over an IP network,
wherein the communication method further comprises collecting or manually receiving, by the upper-level controller, IP network information by analyzing the packet transmitted and received between the first router and the second router.

9. The communication method of claim 1,
wherein the SDN comprises
a first unit network comprising a transmitting terminal;
a second unit network;
a third unit network;
a fourth unit network comprising a receiving terminal;
a first router connecting the first unit network and the second unit network;
a second router connecting the second unit network and the third unit network;
a first lower-level controller configured to manage the first unit network;
a second lower-level controller configured to manage the second unit network;
a first upper-level controller configured to manage the first lower-level controller and the second lower-level controller;
a third lower-level controller configured to manage the third unit network;
a fourth lower-level controller configured to manage the fourth unit network;
a second upper-level controller configured to manage the third lower-level controller and the fourth lower-level controller; and
an top-level controller configured to manage the first upper-level controller and the second upper-level controller,
wherein the controlling of communication comprises:
transmitting, transmitting terminal in the first unit network, transmitting a query message including an IP address of the receiving terminal in the fourth unit network to the first lower-level controller in order to transmit a packet to the receiving terminal;
checking, by the first lower-level controller, if the IP address of the receiving terminal is within the first unit network, and, if not, transmitting the query message to the first upper-level controller; and
checking, by the first upper-level controller, if the IP address of the receiving terminal is within the second unit network, and, if not, transmitting the query message to the top-level controller.

10. The communication method of claim 9,
wherein the controlling of communication comprises:
checking, by the top-level controller having received the query message , that the IP address of the receiving terminal is within the fourth unit network, and transmitting a link layer address of the second router to the first upper-level controller;
transmitting, by the first upper-level controller, a link layer address of the first router to the transmitting terminal;
transmitting, by the transmitting terminal, a packet to the link layer address of the first router;
transmitting, by the first router, the packet to the link layer address of the second router; and
transmitting, by the second router, the packet to the receiving terminal.

11. The communication method of claim 10,
wherein the controlling of communication further comprises:
in a case where the first router is not informed of the link layer address of the second router, transmitting, by the first router, a query message requesting for the link layer address of the second router from the second lower-level controller through a transport device, transmitting, by the second lower-level controller, the query message requesting for the link layer address of the second router from the first upper-level controller, transmitting, by the first upper-level controller, the query message requesting for the link layer address of the second router from the top-level controller, and, in turn, acquiring the link layer address of the second router from the top-level controller.

12. A software-defined network (SDN) system comprising:
a plurality of lower-level controller configured to manage different unit networks, respectively; and
an upper-level controller configured to manage the plurality of lower-level controllers,
wherein in a case where the plurality of lower-level controllers abstract the respective unit networks and provide the abstracted unit networks to the upper-level controller, the upper-level controller controls communication between the abstracted unit networks.

13. The SDN system of claim 12, further comprising:
a first unit network comprising a transmitting terminal;
a second unit network comprising a receiving terminal;
a router configured to connect the first unit network and the second unit network;
a first lower-level controller configured to manage the first unit network;
a second lower-level controller configured to manage the second unit network; and
a upper-level controller configured to manage the first lower-level controller and the second lower-level controller.

14. The SDN system of claim 13,
wherein the transmitting terminal in the first unit network transmits a query message including an IP address of the receiving terminal in the second unit network to the first lower-level controller in order to transmit a packet to the receiving terminal,
wherein the first lower-level controller checks if the IP address of the receiving terminal is within the first unit network, and, if not, transmits the query message to the upper-level controller.

15. The SDN system of claim 13,
wherein the router comprises the first router and the second router which are connected to each other over an IP network,
wherein the transmitting terminal and the receiving terminal communicate between the first unit network and the second unit network through the IP network.

16. The SDN system of claim 12, further comprising:
a first unit network comprising a transmitting terminal;
a second unit network;
a third unit network;
a fourth unit network comprising a receiving terminal;
a first router configured to connect the first unit network and the second unit network;
a second router configured to connect the second unit network and the third unit network;
a first lower-level controller configured to manage the first unit network;
a second lower-level controller configured to manage the second unit network;
a first upper-level controller configured to manage the first lower-level controller and the second lower-level controller;
a third lower-level controller configured to manage the third unit network;
a fourth lower-level controller configured to manage the fourth unit network;
a second upper-level controller configured to manage the third lower-level controller and the fourth lower-level controller; and
a utmost controller configured to manage the first upper-level controller and the second upper-level controller.

17. The SDN system of claim 16,
wherein the transmitting terminal in the first unit network transmits a query message including an IP address of the receiving terminal in the fourth unit network to the first lower-level controller in order to transmit a packet to the receiving terminal,
wherein the first lower-level controller checks if the IP address of the receiving terminal is within the first unit network, and, if not, transmits the query message to the first upper-level controller,
wherein the first upper-level checks if the IP address of the receiving terminal is within the second unit network, and, if not, transmitting the query message to the top-level controller.

18. The SDN system of claim 12, further comprising:
a first IP network connected to a transmitting terminal;
a second IP network connected to a receiving terminal;
a first router connected to the first IP network;
a second router connected to the second IP network; and
at least one unit network configured connect the first router and the second router,
wherein the transmitting terminal connected to the first IP network communicates with the receiving terminal connected to the second IP network through the at least one unit network.
